(19) United States
(12) Patent Application Publication
(10) Pub. No.: US 2014/0037088 A1
(43) Pub. Date: Feb. 6, 2014

(54) CRYPTOGRAPHIC METHOD, CRYPTOGRAPHIC DEVICE, AND CRYPTOGRAPHIC PROGRAM

(71) Applicants: Tomoyasu Suzaki, Tokyo (JP); Yukiyasu Tsundo, Tokyo (JP)

(72) Inventors: Tomoyasu Suzaki, Tokyo (JP); Yukiyasu Tsundo, Tokyo (JP)

(73) Assignee: NEC CORPORATION, Tokyo (JP)

(21) Appl. No.: 14/111,141

(22) PCT Filed: Apr. 11, 2012
(86) PCT No.: PCT/JP2012/059853

§ 371 Date: Oct. 10, 2013

(30) Foreign Application Priority Data
Apr. 11, 2011 (JP) 2011-087088

(51) Int. Cl. H04L 9/08

(52) U.S. Cl. CPC H04L 9/0816
USPC 380/44

(57) ABSTRACT

K-sequence-data randomizing processing is performed a predetermined number of times. One round of the processing includes steps of: performing conversion processing on k pieces (k is an even number of 6 or more) of n-bit sequence data obtained by dividing n×k bit block data so that i-th sequence data and (i+1)th sequence data (i=1, 2, . . . , k−1) interacts with each other and outputting k pieces of data W₁, W₂, . . . , Wₖ; and permutating the data W₁, W₂, . . . , Wₖ based on a predetermined rule.

### TECHNICAL FIELD

### Reference to Related Application

The present invention is based upon and claims the benefit of the priority of Japanese patent application No. 2011-087088, filed on Apr. 11, 2011, the disclosure of which is incorporated herein in its entirety by reference thereto.

The present invention relates to a cryptographic method, a cryptographic device, and a cryptographic program. In particular, it relates to a cryptographic method, a cryptographic device, and a cryptographic program for performing encryption per block by using a common key (secret key).

### BACKGROUND

Common key block cipher (which will simply be referred to as “block cipher”) is known as a technique for keeping communication data or accumulated data secret. “Feistel structure” is one of the basic structures of such block cipher. FIG. 11 illustrates a configuration of one round of a Feistel structure having a block length of 2n bits. Input data is divided into two n-bit data B₁ and B₂, and the data B₁ and key data Kᵣ are randomized with a function F. Next, exclusive OR is performed on the data outputted from the function F and the data B₂. As a result, data B′₁ is obtained. The data B₁ is used directly as data B′₂. The data B′₁ and B′₂ obtained in this way is inputted to the next round.

In addition, Non Patent Literature (NPL) 1 discloses a Generalized Feistel structure (which is referred to as “Feistel Type Transformation” in NPL 1). With this structure, the division number of the Feistel structure is extended to 2 or more.

While NPL 1 proposes three types (Type-1 to Type-3) of structures, the present description will be made based on Type-2 (hereinafter, the phrase “Generalized Feistel structure” signifies Type-2, unless otherwise noted).

FIG. 12 illustrates a configuration of one round of a Generalized Feistel structure in which input data is first divided into k (an even number of 2 or more) pieces (each divided data will hereinafter be referred to as “a sequence”) and the sequences are next processed (such Generalized Feistel structure will hereinafter be referred to as “k-sequence Generalized Feistel structure”).

Processing performed by a non-linear conversion unit 20 and processing performed by a permutation processing unit 21 in one round of the Generalized Feistel structure will be examined separately. Of the inputted k-sequence data, the non-linear conversion unit 20 directly outputs data Xᵢ (i is an odd number of k or less). In addition, the non-linear conversion unit 20 randomizes the data Xᵢ and key data Kⱼ (j=(i+1)/2) with a function F and performs exclusive OR on the obtained data and data Xᵢ₊₁. Next, the non-linear conversion unit 20 outputs the resultant data. The permutation processing unit 21 performs permutation processing to cyclically shift the sequence data in the left direction by one sequence.

### CITATION LIST

### Non Patent Literature

### NPL 1

Y. Zheng, T. Matsumoto, H. Imai, “On the Construction of Block Ciphers Provably Secure and Not Relying on Any Unproved Hypotheses,” CRYPTO 1989, LNCS vol. 435, pp. 461-480, Springer-Verlag, 1998.

### SUMMARY

### Technical Problem

The disclosure of the above NPL is incorporated herein by reference thereto. The following analysis has been given by the present inventor. In block cipher, each bit data of the input data (plaintext) needs to influence all the bits of the output data (ciphertext), and it is desirable that an encryption algorithm efficiently diffuse the bit data.

However, as illustrated in FIG. 12, if the Generalized Feistel structure is used, while the odd sequence data of the divided sequence data is diffused into the even sequence data via the respective functions F, the even sequence data is simply shifted to the odd sequence data, without being diffused. Thus, if a certain round is examined, difference is seen in diffusion between the odd sequence data and the even sequence data.

In addition, in block cipher having the Generalized Feistel structure, if the division number k is increased, the functions F can be minimized, counted as an advantageous effect. However, the number of rounds to be applied to an impossible differential attack and a saturation attack is increased. Thus, as a measure, the number of rounds needs to be increased. Consequently, the processing speed is reduced, counted as a problem.

It is an object of the present invention to provide a cryptographic method, a cryptographic device, and a cryptographic program that can achieve excellent diffusion properties and a smaller round number.

### Solution to Problem

According to a first aspect of the present invention, there is provided a cryptographic method, performing k-sequence-data randomizing processing a predetermined number of times. One round of the processing includes steps of: performing conversion processing on k pieces (k is an even number of 6 or more) of n-bit sequence data obtained by dividing nxk bit block data so that i-th sequence data and (i+1)th sequence data (i=1, 2, . . . , k−1) interacts with each other and outputting k pieces of data W₁, W₂, . . . , Wₖ; and permutating the data W₁, W₂, . . . , Wₖ based on a predetermined rule. This method is associated with a certain machine, that is, with a cryptographic device that performs cryptographic processing for keeping data secret when the data is communicated or accumulated.

According to a second aspect of the present invention, there is provided a cryptographic device, comprising: a predetermined number of rounds of k-sequence-data randomizing means. One round of the means includes: a conversion means for performing conversion processing on k pieces (k is an even number of 6 or more) of n-bit data obtained by dividing n×k bit block data so that i-th sequence data and (i+1)th sequence data (i=1, 2, . . . , k−1) interacts with each other and outputting k pieces of data W₁, W₂, . . . , Wₖ; and a permutation means for permutating the data W₁, W₂, . . . , Wₖ based on a predetermined rule.

According to a third aspect of the present invention, there is provided a cryptographic program, causing a computer, to which k pieces (k is an even number of 6 or more) of n-bit data obtained by dividing nxk bit block data is inputted, to perform k-sequence-data randomizing processing for a predetermined number of rounds. One round of the processing includes processes of: performing conversion processing so that i-th sequence data and (i+1)th sequence data (i=1, 2, . . . , k−1) interacts with each other and outputting k pieces of data W₁, W₂, . . . , Wₖ; and permutating the data W₁, W₂, . . . , Wₖ based on a predetermined rule. This program can be recorded in a computer-readable (non-transient) storage medium. Namely, the present invention can be embodied as a computer program product.

### Advantageous Effects of Invention

According to the present invention, it is possible to obtain a configuration that ensures resistance to an impossible differential attack and a saturation attack with a smaller round number.

### BRIEF DESCRIPTION OF DRAWINGS

FIG. 1 illustrates an outline of the present invention.

FIG. 2 illustrates a detailed configuration of a non-linear conversion unit in FIG. 1.

FIG. 3 illustrates another configuration of the non-linear conversion unit in FIG. 1.

FIG. 4 illustrates another configuration of the non-linear conversion unit in FIG. 1.

FIG. 5 illustrates a data diffusion state according to the present invention when eight sequences are used.

FIG. 6 illustrates a data diffusion state according to a Generalized Feistel structure when eight sequences are used.

FIG. 7 illustrates a configuration of a communication device according to a first exemplary embodiment of the present invention.

FIG. 8 illustrates detailed configurations of an encryption means and a decryption means in the communication device according to the first exemplary embodiment of the present invention.

FIG. 9 illustrates a detailed configuration of a k-sequence-data randomizing means in the encryption means in the communication device according to the first exemplary embodiment of the present invention.

FIG. 10 illustrates a detailed configuration of a k-sequence-data randomizing means in the decryption means in the communication device according to the first exemplary embodiment of the present invention.

FIG. 11 illustrates a configuration of a Feistel structure.

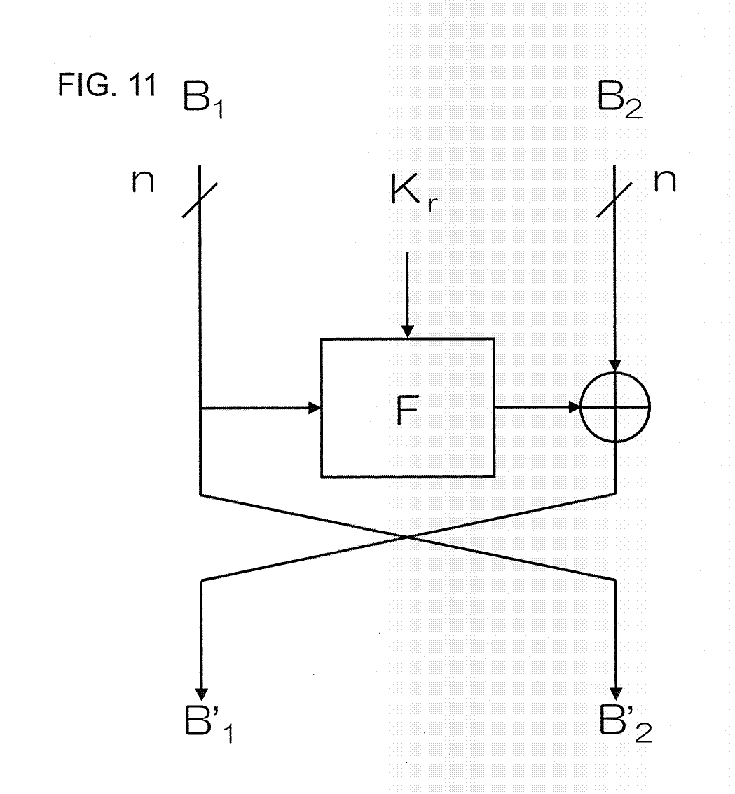

FIG. 12 illustrates a configuration of a Generalized Feistel structure.

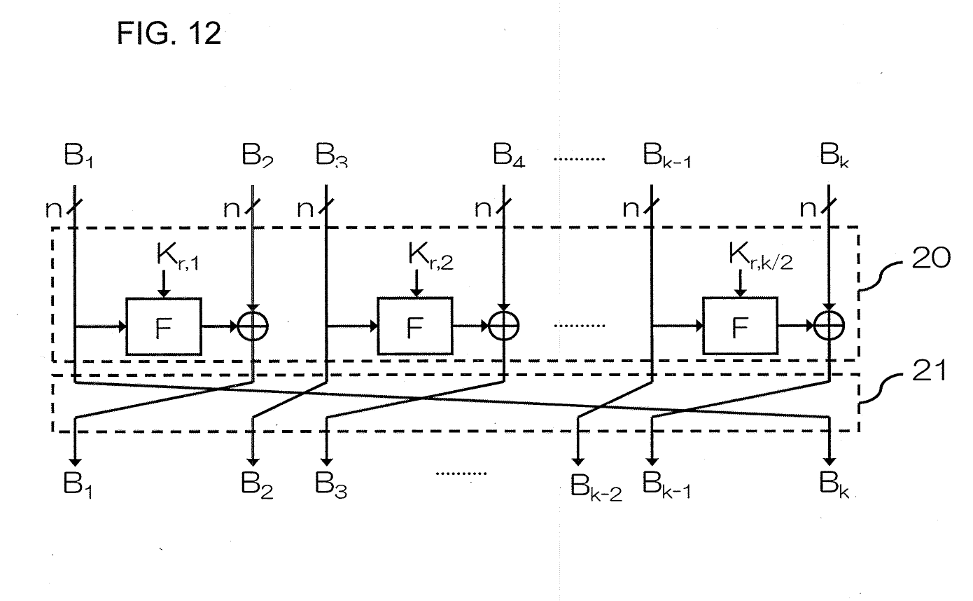

### DESCRIPTION OF EMBODIMENTS

First, an outline of the present invention will be described with reference to the drawings. In the following outline, various components are denoted by reference characters for the sake of convenience. Namely, the following reference characters are merely used as examples to facilitate understanding of the present invention. Thus, the present invention is not limited to the illustrated modes.

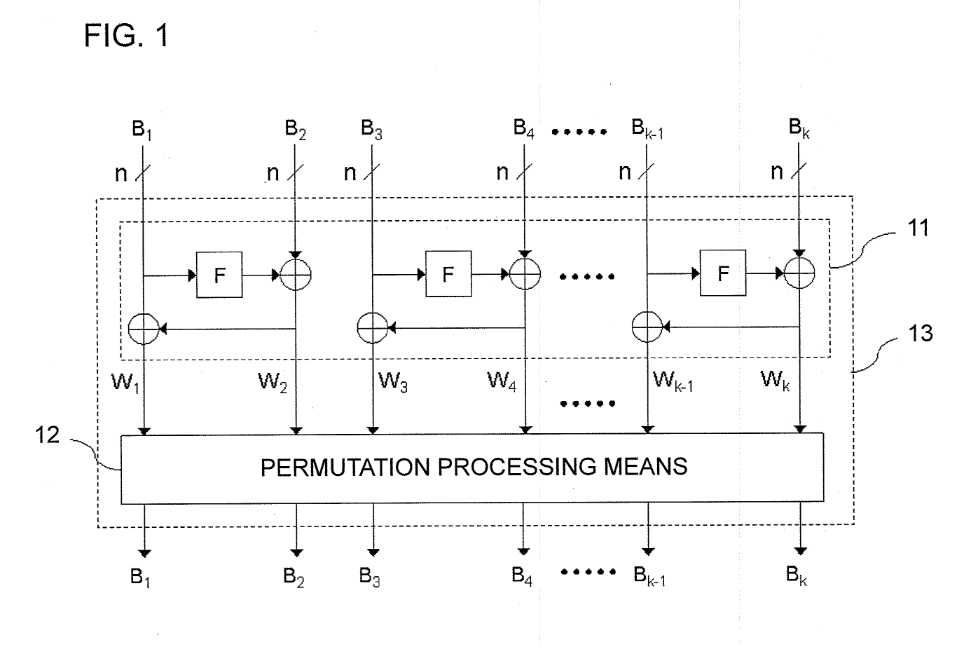

As illustrated in FIG. 1, the present invention can be realized by a configuration including a k-sequence-data randomizing means 13. One round of the randomizing means is formulated by including non-linear conversion means 11 for perform conversion processing on k pieces (k is an even number of 6 or more) of n-bit sequence data B₁ to Bₖ obtained by dividing n×k bit block data so that i-th sequence data B, and (i+1)th sequence data Bᵢ₊₁ interacts with each other to output k data W₁, W₂, . . . , Wₖ; and permutation processing means 12 for permutating the data W₁, W₂, . . . , Wₖ based on a predetermined rule.

Specifically, k-sequence-data randomizing processing is performed a predetermined number of times. One round of the processing includes steps of: performing conversion processing on the k pieces of n-bit sequence data B₁ to Bₖ so that the i-th sequence data Bi and the (i+1)th sequence data Bᵢ₊₁ interacts with each other and outputting k data W₁, W₂, . . . , Wₖ; and permutating the data W₁, W₂, . . . , Wₖ based on a predetermined rule (permutation processing is not performed in the final round).

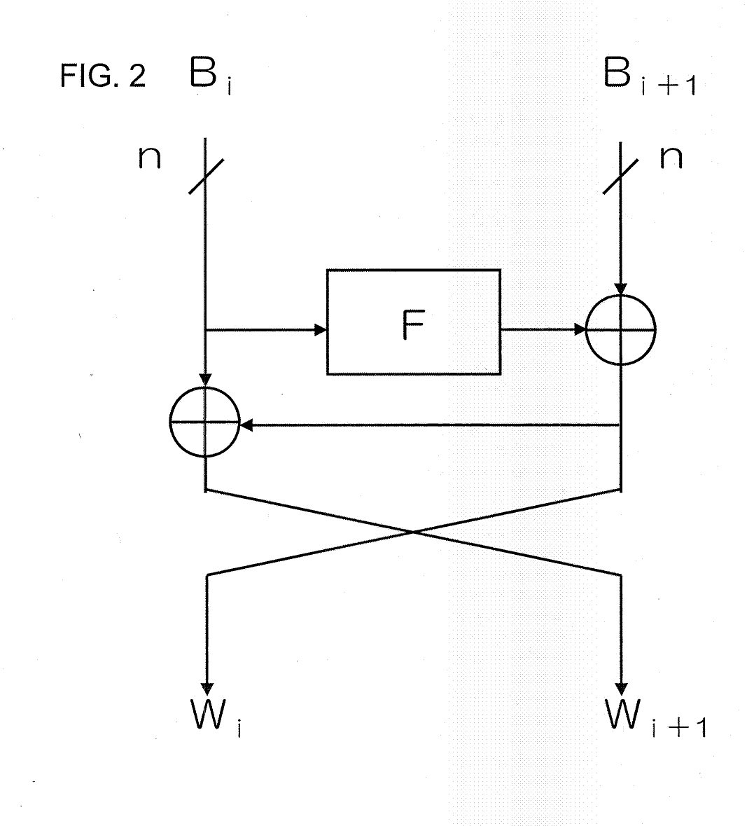

FIG. 2 illustrates a detailed configuration of the non-linear conversion means 11 in FIG. 1. In the conversion processing in FIG. 2, the i-th sequence data Bᵢ is inputted to a non-linear function F, and the data Bi and predetermined key data (not illustrated) are randomized with a non-linear function F. Next, exclusive OR operation on the output data of non-linear function F and the other data Bᵢ₊₁ are subjected to, and data Wᵢ is obtained as a result. Next, exclusive OR is performed on the data Wᵢ and the data Bᵢ, and data Wᵢ₊₁ is obtained as a result. In a case of k sequences, k/2 configurations, each of which corresponds to that as illustrated in FIG. 2, are arranged in parallel.

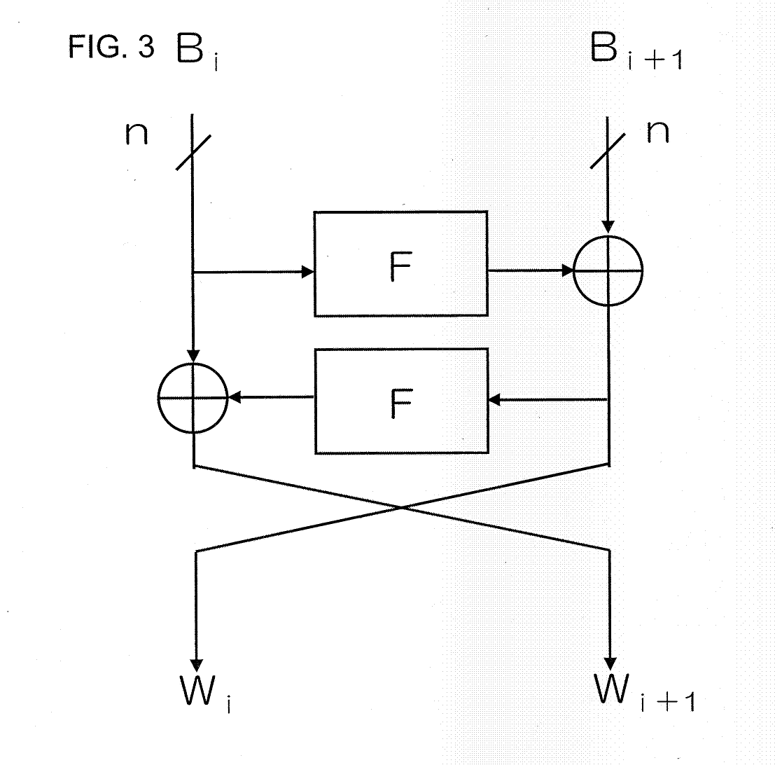

The non-linear conversion means 11 in FIG. 1 may be configured as illustrated in FIG. 3. Namely, first, exclusive OR (operation) is performed on the output from the first non-linear function F and the sequence data Bᵢ₊₁. Next, the resultant data Wⁱ is inputted to another (second) non-linear function F where the data Wᵢ is randomized before interacted with the data Bᵢ. More specifically, in FIG. 3, before exclusive OR is performed on the data Wᵢ and the sequence data Bᵢ, the data Wᵢ is inputted to a non-linear function F where the data Wᵢ and predetermined key data (not illustrated) are randomized. Next, exclusive OR is performed on the output from the (second) non-linear function F and the data Bᵢ, and data Wᵢ₊₁ is obtained as a result.

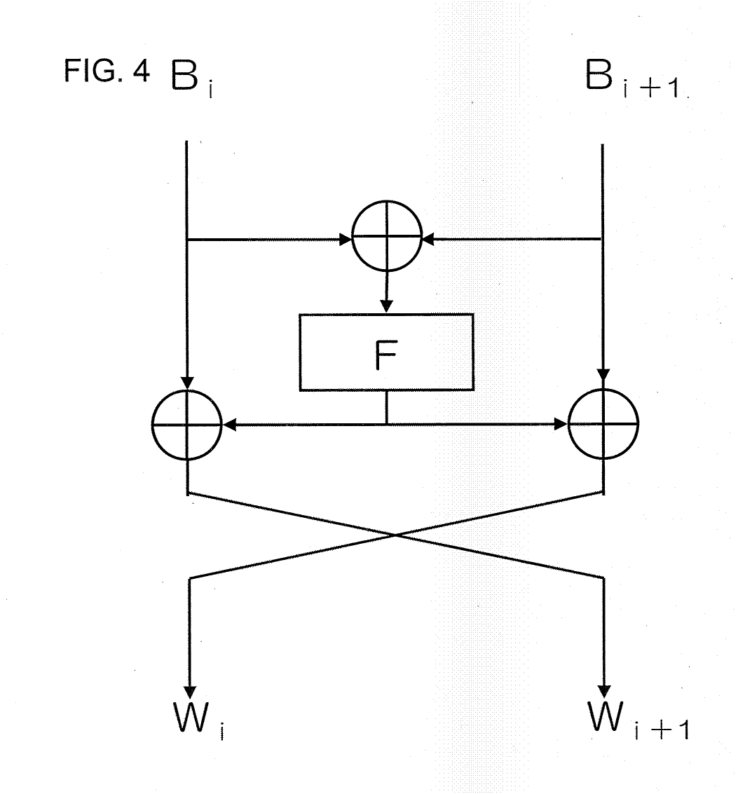

Alternatively, as illustrated in FIG. 4, the non-linear conversion unit 11 in FIG. 1 may use the Lai-Massey Scheme. In FIG. 4, exclusive OR is performed on the i-th sequence data Bᵢ and the (i+1)th sequence data Bᵢ₊₁, and the obtained data is inputted to a non-linear function F. Exclusive OR is performed on the data outputted from the non-linear function F and the data Bᵢ, and data Wᵢ₊₁ is obtained as a result. In addition, exclusive OR is performed on the data outputted from the non-linear function F and the data Bᵢ₊₁, and data Wᵢ is obtained as a result.

In addition, by combining the above bi-directional non-linear conversion processing with permutation processing determined in advance based on the number of sequences not with cyclic shifting, diffusion properties can be improved further.

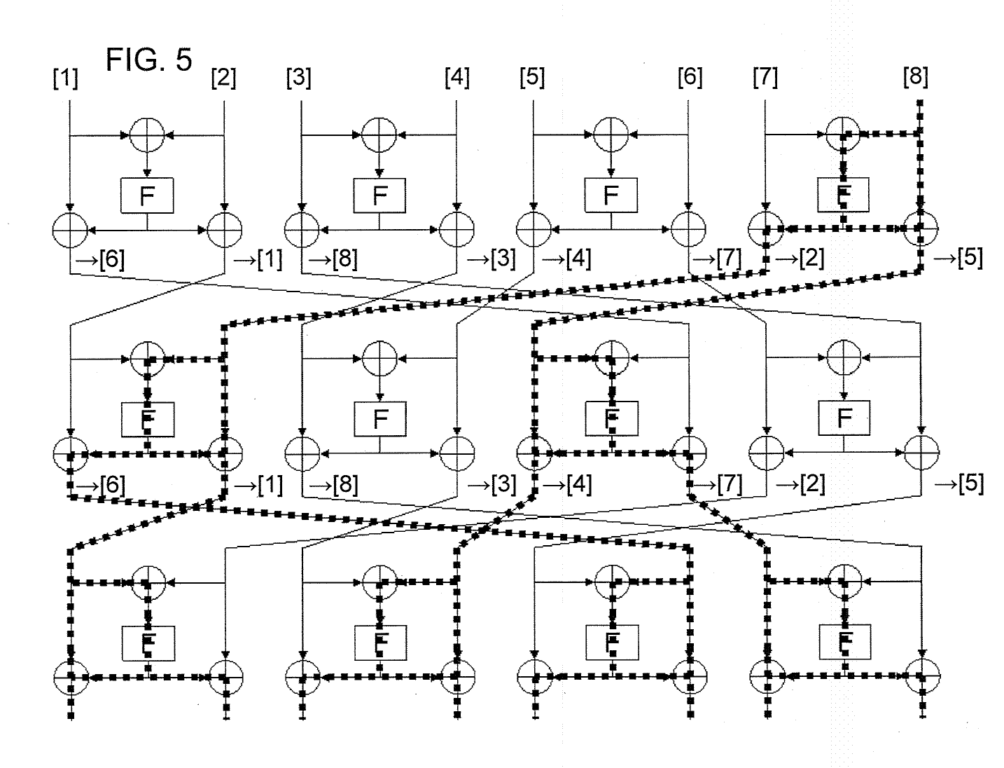

FIG. 5 illustrates a data propagation (i.e. diffusion) state observed when permutation processing is performed on the condition that the sequence number k is 8 and the above Lai-Massey Scheme in FIG. 4 is applied to the non-linear conversion processing, in which, W₁, W₂, . . . , and W₈ is propagated (permutated) to W₆, W₁, W₈, W₃, W₄, W₂, W₇, W₅. As illustrated by thick dashed lines in FIG. 5, it is seen that data in the sequence 8 is diffused into all the sequences after three rounds. In addition, while the Lai-Massey Scheme in FIG. 4 is used in FIG. 5, as can be clear by comparing FIGS. 2 to 4, like results can be obtained even when the non-linear conversion units 11 in FIGS. 2 and 3 are used.

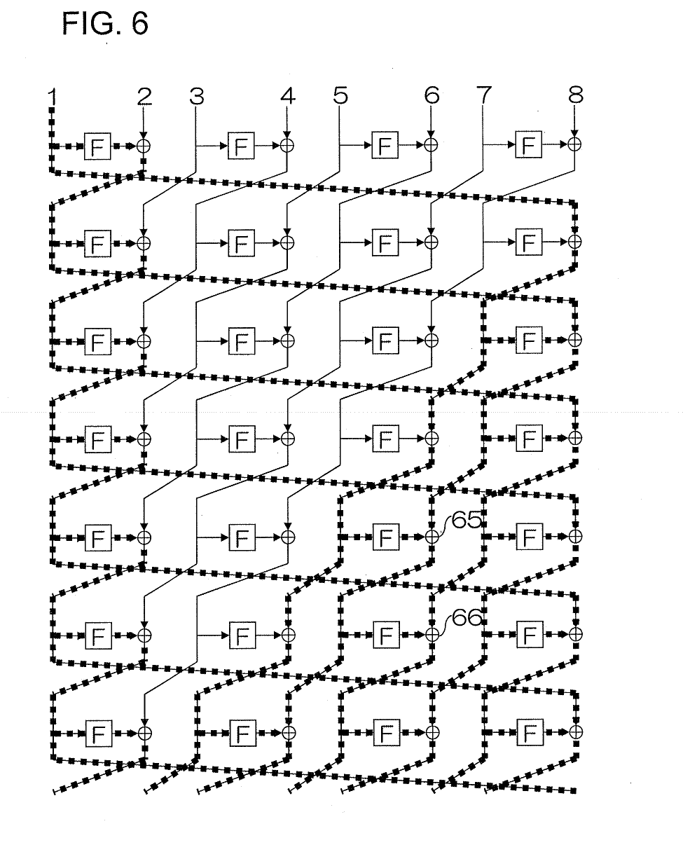

FIG. 6 illustrates a diffusion state observed when an 8-sequence Generalized Feistel structure is used. Seven rounds are required for the data in sequence 1 to be diffused to all the sequences. The present invention can reduce the necessary round number by ½ or less.

According to the present invention, since the above permutation processing only exchange-replaces (i.e. permutates) the bit data, irrespective of whether hardware implementation method or software implementation method is used, the implementation cost is not increased by any change in permutation pattern, counted as an advantageous effect.

### First Exemplary Embodiment

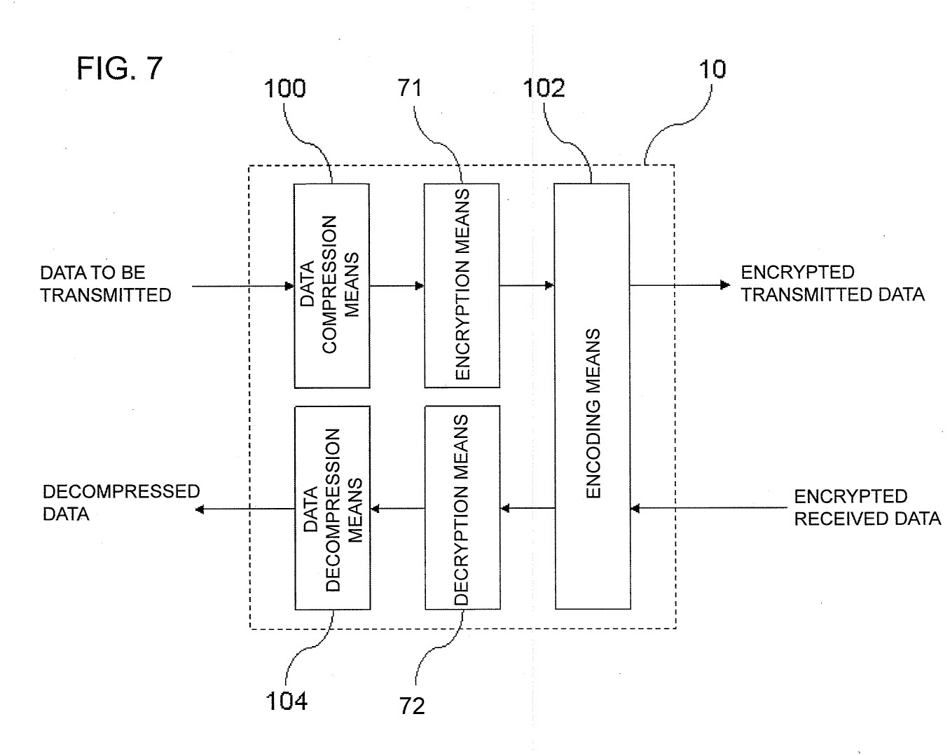

Next, a first exemplary embodiment of the present invention will be described in detail with reference to the drawings. FIG. 7 illustrates a configuration of a communication apparatus according to the first exemplary embodiment of the present invention. FIG. 7 illustrates a communication apparatus 10 including data compression means 100 compressing data, encryption means 71 encrypting compressed data, encoding means 102 performing encoding processing, decryption means 72 decrypting data outputted from the encoding means 102, and data decompression means 104 performing data decompression processing.

When transmitting data, such communication apparatus 10 causes the data compression means 100 to compress the data, the encryption means 71 to encrypt the data, and the encoding means 102 to perform error correcting encoding. In this way, the communication apparatus 10 transmits encrypted transmitted data.

In addition, when receiving data, the communication apparatus 10 causes the encoding means 102 to perform error correction, the decryption means 72 to decrypt the data, and the data decompression means 104 to decompress the data to obtain decompressed data.

Specific examples of the above communication apparatus 10 include various devices that need to keep communication data secret, such as voice communication terminals and data communication devices. In addition, in FIG. 7, the communication apparatus 10 includes both the encryption means 71 and the decryption means 72. However, if the communication apparatus 10 performs only data transmission or data reception, the communication apparatus 10 may include at least one of the encryption means 71 and the decryption means 72.

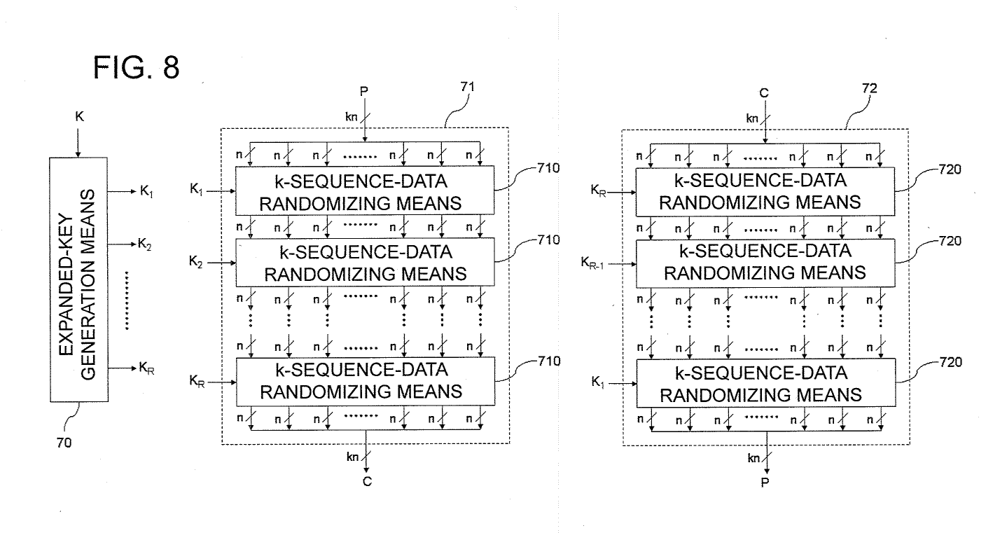

FIG. 8 illustrates detailed configurations of the above encryption means and decryption means. An expanded-key generation means 70 generates a plurality of expanded keys K₁, K₂, . . . , K_{R} from key data K and supplies the expanded keys K₁, K₂, . . . , K_{R} to the encryption means 71 and the decryption means 72.

The encryption means 71 includes a predetermined round number R of k-sequence-data randomizing means 710 (k is an even number of 6 or more). The encryption means 71 outputs one block of ciphertext data C with respect to input of one block of plaintext data P and the expanded keys K₁, K₂, . . . , K_{R}. More specifically, first, the encryption means 71 divides kn bit plaintext data P into k pieces of n-bit data and inputs the data and key data K₁ to a k-sequence-data randomizing means 710 to randomize the data. Subsequently, the k-sequence-data randomizing means 710 in an r-th round (2≦r≦R) receives the output from the k-sequence-data randomizing means 710 in an (r−1)th round and key data Kᵣ. In this way, the data and the expanded keys are repeatedly randomized. Finally, kn bit data in which the k pieces of outputs are combined are outputted as ciphertext data C from the k-sequence-data randomizing means 710 in an R-th round.

The decryption means 72 includes a predetermined round number of k-sequence-data randomizing means 720. The decryption means 72 outputs one block of plaintext data P with respect to input of one block of ciphertext data C and the expanded keys K₁, K₂, . . . , K_{R}. As is the case with the encryption means 71, first, the decryption means 72 divides kn bit ciphertext data P into k pieces of n-bit data and inputs the data and key data K₁ to a k-sequence-data randomizing means 710 to randomize the data. Subsequently, the k-sequence-data randomizing means 720 in a r-th round (2≦r≦R) receives the output from the k-sequence-data randomizing means 720 in an (r−1)th round and key data Kᵣ. In this way, the data and the expanded keys are repeatedly randomized. Finally, kn bit data in which the k pieces of outputs are combined are outputted as the plaintext data P from the k-sequence-data randomizing means 720 in an R-th round. In the decryption means 72, the expanded keys are used in an order opposite to that of the expanded keys used in the encryption means 71 (see the indexes attached to the respective key data in FIG. 8).

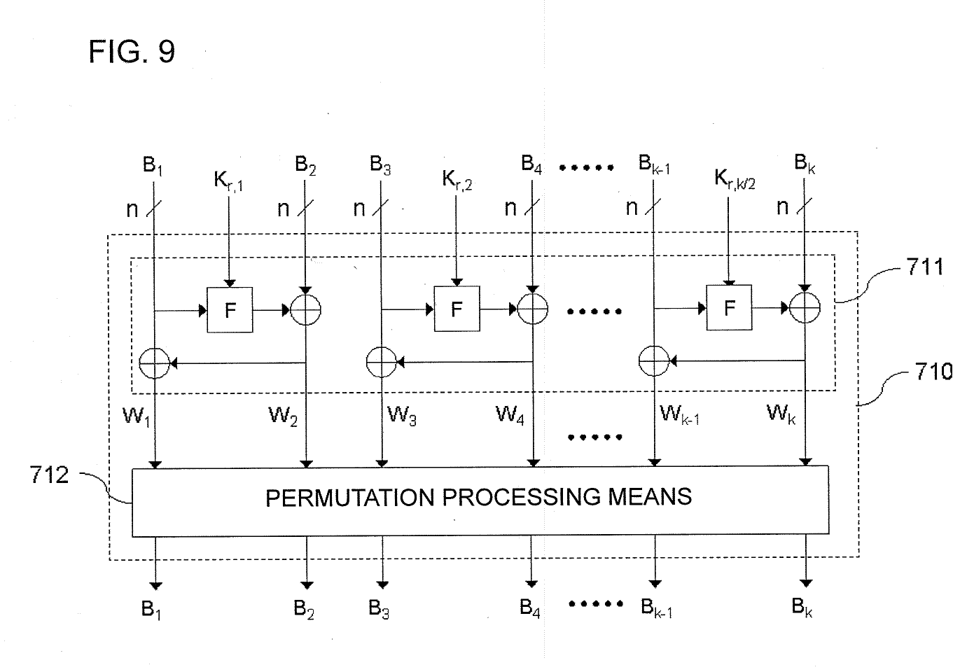

FIG. 9 illustrates a detailed configuration of k-sequence-data randomizing means 710 in the encryption means 71. As illustrated in FIG. 9, the k-sequence-data randomizing means 710 includes non-linear conversion means 711 and permutation processing means 712. However, the k-sequence-data randomizing means 710 in the R-th round includes non-linear conversion means 711 alone.

In the non-linear conversion means 711, k/2 configurations are arranged in parallel, each of which corresponds to that as illustrated in one of FIGS. 2 to 4. In each of the configurations, data is operated bi-directionally. In addition, in FIG. 9, expanded key data K, is equally divided into k/2 key data, each of which is inputted to an F function. However, if the configuration in FIG. 3 is used, since two F functions are necessary, the expanded key data Kᵢ is equally divided into k/4 key data.

Depending on the sequence number k, the permutation processing means 712 permutates k pieces of intermediate data in accordance with a predetermined permutation pattern.

Next, permutation patterns will be described in detail. A permutation from data Wᵢ to W_{j[i]} will be expressed as {j[1],j[2], . . . ,j[k]}. The following permutation patterns can be used as the permutation patterns for respective sequence numbers k.

When six sequences are used (k=6),

{4,1,2,5,6,3};

When eight sequences are used (k=8),

{,1,8,3,4,7,2,5}

{4,1,8,5,6,7,2,3};

When 10 sequences are used (k=10),

{4,1,8,3,10,5,6,9,2,7}

{4,1,6,3,10,7,2,9,8,5}

{4,1,6,3,10,7,8,9,2,5}

{6,1,8,3,4,7,2,9,10,5}

{6,1,8,3,10,7,2,9,4,5}

{6,1,8,3,10,7,4,9,2,5}

{4,1,8,5,2,3,6,9,10,7}

{4,1,8,5,2,7,6,9,10,3}

{4,1,8,5,10,7,6,9,2,3};

When 12 sequences are used (k=12),

{8,1,10,3,12,5,4,9,6,11,2,7}

{6,1,10,3,12,7,2,5,8,11,4,9}

{6,1,10,3,12,7,4,5,8,11,2,9}

{6,1,8,3,4,7,12,9,10,11,2,5}

{6,1,10,3,4,7,12,9,2,11,8,5}

{6,1,10,3,12,7,2,9,8,11,4,5}

{6,1,10,3,12,7,4,9,8,11,2,5}

{4,1,8,5,2,3,12,9,6,11,10,7}

{4,1,8,5,2,3,12,9,10,11,6,7}

{4,1,12,5,10,7,6,9,8,11,2,3}

{6,3,10,1,4,7,12,5,8,11,2,9}

{6,3,10,1,12,7,4,5,8,11,2,9}

{6,3,10,1,12,7,2,9,8,11,4,5}

{6,3,10,1,12,7,4,9,8,11,2,5}

{6,3,2,5,8,1,12,9,4,11,10,7};

When 14 sequences are used (k=14),

{4,1,10,5,14,7,6,3,2,11,12,13,8,9}

{4,1,10,5,6,7,2,9,14,11,8,13,12,3};

When 16 sequences are used (k=16),

{10,1,14,3,12,7,16,5,8,11,4,13,6,15,2,9}

{6,1,8,3,12,7,16,9,2,5,4,13,10,15,14,11}

{6,1,12,3,16,7,4,9,2,5,10,13,8,15,14,11}

{6,1,12,3,16,7,14,9,2,5,10,13,8,15,4,11}

{6,1,8,3,12,7,16,9,14,11,4,13,10,15,2,5}

{6,1,10,3,14,7,4,9,16,11,8,13,12,15,2,5}

{6,1,10,3,14,7,12,9,16,11,8,13,4,15,2,5}

{8,1,10,5,14,3,6,9,16,11,12,13,4,15,2,7}

{8,1,10,5,16,3,6,9,14,11,12,13,4,15,2,7}

{8,1,10,5,16,3,14,9,6,11,12,13,4,15,2,7}

{4,1,10,5,16,7,6,3,14,11,12,13,8,15,2,9}

{10,1,2,5,12,7,6,3,8,11,16,13,14,15,4,9}

{4,1,10,5,16,7,6,9,14,11,12,13,8,15,2,3}.

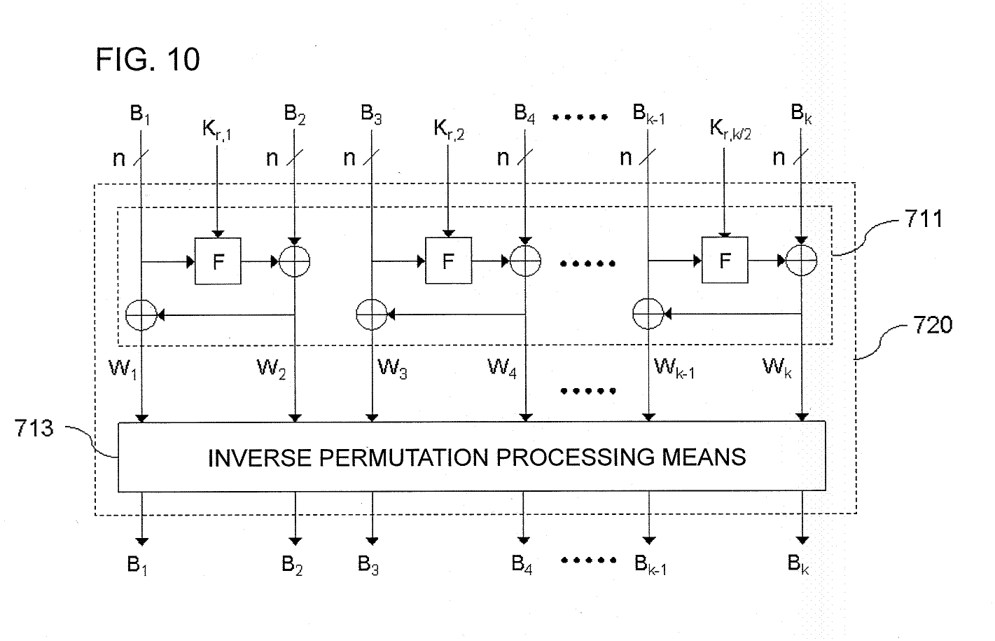

FIG. 10 illustrates a detailed configuration of k-sequence-data randomizing means 720 in the decryption means 72. As illustrated in FIG. 10, the k-sequence-data randomizing means 720 includes non-linear conversion means 711 and inverse permutation processing means 713. The k-sequence-data randomizing means 710 in the R-th round includes the non-linear conversion means 711 alone.

As is the case with the encryption means 71, in the non-linear conversion means 711, k/2 configurations are arranged in parallel. In each of the configurations, data is operated bi-directionally as illustrated in FIGS. 2 to 4.

The inverse permutation processing means 713 performs permutation opposite to that performed by a permutation processing means 712 in the encryption means 71. For example, if a permutation processing means 712 in the encryption means 71 performs a permutation from data in sequence i to sequence j, an inverse permutation processing means 713 performs a permutation from data sequence j to sequence i.

The expanded-key generation means 70, the encryption means 71, the decryption means 72, and the processing means inside the respective means illustrated in FIGS. 8 to 10 can be realized by a computer program causing a computer constituting the communication apparatus 10 to use hardware of the computer and to perform the above processing. Of course, the above means can be realized by hardware or the like such as an LSI (Large Scale Integration) mounted on the communication apparatus 10.

As described, by performing conversion processing so that the i-th and (i+1)th sequence data interacts each other and by permutating data W₁, W₂, . . . , Wₖ, cryptographic/decryptographic means achieving excellent diffusion properties with less rounds as illustrated in FIG. 5 can be obtained.

Finally, preferable modes of the present invention will be summarized.

### First Mode

(See the cryptographic method according to the above first aspect)

### Second Mode

In the conversion processing of the cryptographic method in the first mode, one of the i-th sequence data and the (i+1)th sequence data is inputted to a non-linear function, and exclusive OR is performed on the data obtained by the non-linear function and on the other data. The data obtained by the exclusive OR is used as data W. Exclusive OR is performed on the data W, and the one data, and the obtained data is used as data Wᵢ₊₁.

### Third Mode

In the cryptographic method in the second mode, before exclusive OR is performed on the data Wᵢ and the one data, the data Wᵢ is inputted to a non-linear function and exclusive OR is performed on an output from this non-linear function and the one data. The data obtained by the exclusive OR is used as data Wᵢ₊₁.

### Fourth Mode

In the conversion processing of the cryptographic method in the first mode, exclusive OR is performed on the i-th sequence data and the (i+1)th sequence data, and the data obtained by the exclusive OR is inputted to a non-linear function. Exclusive OR is performed on the data obtained by the non-linear function and the one data, and the data obtained by the exclusive OR is used as Wᵢ₊₁. Exclusive OR is performed on the data outputted from the non-linear function and the other data. The data obtained by the exclusive OR is used as data Wᵢ.

### Fifth Mode

In the cryptographic method in any one of the first to fourth modes, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=6, a permutation expressed as {4,1,2,5,6,3} is performed.

### Sixth Mode

In the cryptographic method in any one of the first to fifth modes, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=8, a permutation expressed as {6,1,8,3,4,7,2,5} or {4,1,8,5,6,7,2,3} is performed.

### Seventh Mode

In the cryptographic method in the any one of the first to sixth modes, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=10, a permutation expressed as any one of the following expressions (1) is performed:

{4,1,8,3,10,5,6,9,2,7}

{4,1,6,3,10,7,2,9,8,5}

{4,1,6,3,10,7,8,9,2,5}

{6,1,8,3,4,7,2,9,10,5}

{6,1,8,3,10,7,2,9,4,5}

{6,1,8,3,10,7,4,9,2,5}

{4,1,8,5,2,3,6,9,10,7}

{4,1,8,5,2,7,6,9,10,3}

{4,1,8,5,10,7,6,9,2,3} (1).

### Eighth Mode

In the cryptographic method in any one of the first to seventh modes, if a permutation for replacing the data W₁, W₂, . . . , Wₖ (k≦16) with data W_{j[1i]}, W_{j[2]}, . . . , W_{j[k]} is expressed as {j[1], j[2], . . . , j[k]}, when k=12, a permutation expressed as any one of the following expressions (2) is performed:

{8,1,10,3,12,5,4,9,6,11,2,7}

{6,1,10,3,12,7,2,5,8,11,4,9}

{6,1,10,3,12,7,4,5,8,11,2,9}

{6,1,8,3,4,7,12,9,10,11,2,5}

{6,1,10,3,4,7,12,9,2,11,8,5}

{6,1,10,3,12,7,2,9,8,11,4,5}

{6,1,10,3,12,7,4,9,8,11,2,5}

{4,1,8,5,2,3,12,9,6,11,10,7}

{4,1,8,5,2,3,12,9,10,11,6,7}

{4,1,12,5,10,7,6,9,8,11,2,3}

{6,3,10,1,4,7,12,5,8,11,2,9}

{6,3,10,1,12,7,4,5,8,11,2,9}

{6,3,10,1,12,7,2,9,8,11,4,5}

{6,3,10,1,12,7,4,9,811,2,5}

{6,3,2,5,8,1,12,9,4,11,10,7} (2).

### Ninth Mode

In the cryptographic method in any on firs to eighth modes, if a permutation for replacing the data W₁, W₂, . . . , Wₖ (k≦16) with data W_{j[1]}, W_{[2]}, . . . , W_{j[k]} is expressed as {j[1], j[2], . . . , j[k]}, when k=14, a permutation expressed as {4,1,10,5,14,7,6,3,2,11,12,13,8,9} or {4,1,10,5,6,7,2,9,14,11,8,13,12,3} is performed.

### Tenth Mode

In the cryptographic method in any one of the first to ninth modes, if a Permutation for replacing the data W₁, W₂, . . . , Wₖ (k≦16) with data W_{j[1]}, W_{[2]}, . . . , W_{j[k]} is expressed as {j[1], j[2], . . . , j[k]}, when k=16, a permutation expressed any one of the following expressions (3) is performed:

{10,1,14,3,12,7,16,5,8,11,4,13,6,15,2,9}

{6,1,8,3,12,7,16,9,2,5,4,13,10,15,14,11}

{6,1,12,3,16,7,4,9,2,5,10,13,8,15,14,11}

{6,1,12,3,16,7,14,9,2,5,10,13,8,15,4,11}

{6,1,8,3,12,7,16,9,14,11,4,13,10,15,2,5}

{6,1,10,3,14,7,4,9,16,11,8,13,12,15,2,5}

{6,1,10,3,14,7,12,9,16,11,8,13,4,15,2,5}

{8,1,10,5,14,3,6,9,16,11,12,13,4,15,2,7}

{8,1,10,5,16,3,6,9,14,11,12,13,4,15,2,7}

{8,1,10,5,16,3,14,9,6,11,12,13,4,15,2,7}

{4,1,10,5,16,7,6,3,14,11,12,13,8,15,2,9}

{10,1,2,5,12,7,6,3,8,11,16,13,14,15,4,9}

{4,1,10,5,16,7,6,9,14,11,12,13,8,15,2,3} (3).

### Eleventh Mode

In the cryptographic method in any one of the first to tenth modes, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, depending on the number k of sequences, a permutation expressed as any one of the following expressions (4) is performed:

When k=6,

{4,1,2,5,6,3}

When k=8,

{6,1,8,3,4,7,2,5}

{4,1,8,5,6,7,2,3}

When k=10,

{4,1,8,3,10,5,6,9,2,7}

{4,1,6,3,10,7,2,9,8,5}

{4,1,6,3,10,7,8,9,2,5}

{6,1,8,3,4,7,2,9,10,5}

{6,1,8,3,10,7,2,9,4,5}

{6,1,8,3,10,7,4,9,2,5}

{4,1,8,5,2,3,6,9,10,7}

{4,1,8,5,2,7,6,9,10,3}

{4,1,8,5,10,7,6,9,2,3}

When k=12,

{8,1,10,3,12,5,4,9,6,11,2,7}

{6,1,10,3,12,7,2,5,8,11,4,9}

{6,1,10,3,12,7,4,5,8,11,2,9}

{6,1,8,3,4,7,12,9,10,11,2,5}

{6,1,10,3,4,7,12,9,2,11,8,5}

{6,1,10,3,12,7,2,9,8,11,4,5}

{6,1,10,3,12,7,4,9,8,11,2,5}

{4,1,8,5,2,3,12,9,6,11,10,7}

{4,1,8,5,2,3,12,9,10,11,6,7}

{4,1,12,5,10,7,6,9,8,11,2,3}

{6,3,10,1,4,7,12,5,8,11,2,9}

{6,3,10,1,12,7,4,5,8,11,2,9}

{6,3,10,1,12,7,2,9,8,11,4,5}

{6,3,10,1,12,7,4,9,8,11,2,5}

{6,3,2,5,8,1,12,9,4,11,10,7}

When k=14,

{4,1,10,5,14,7,6,3,2,11,12,13,8,9}

{4,1,10,5,6,7,2,9,14,11,8,13,12,3}

When k=16,

{10,1,14,3,12,7,16,5,8,11,4,13,6,15,2,9}

{6,1,8,3,12,7,16,9,2,5,4,13,10,15,14,11}

{6,1,12,3,16,7,4,9,2,5,10,13,8,15,14,11}

{6,1,12,3,16,7,14,9,2,5,10,13,8,15,4,11}

{6,1,8,3,12,7,16,9,14,11,4,13,10,15,2,5}

{6,1,10,3,14,7,4,9,16,11,8,13,12,15,2,5}

{6,1,10,3,14,7,12,9,16,11,8,13,4,15,2,5}

{8,1,10,5,14,3,6,9,16,11,12,13,4,15,2,7}

{8,1,10,5,16,3,6,9,14,11,12,13,4,15,2,7}

{8,1,10,5,16,3,14,9,6,11,12,13,4,15,2,7}

{4,1,10,5,16,7,6,3,14,11,12,13,8,15,2,9}

{10,1,2,5,12,7,6,3,8,11,16,13,14,15,4,9}

{4,1,10,5,16,7,6,9,14,11,12,13,8,15,2,3} (4).

### Twelfth mode

(See the cryptographic device according to the above second aspect)

### Thirteenth Mode

(See the program according to the above third aspect)

As is the case with the above first mode, the twelfth and thirteenth modes can be extended to the second to eleventh modes.

While a preferable exemplary embodiment of the present invention has thus been described, the present invention is not limited thereto. Further modifications, substitutions, or adjustments can be made without departing from the basic technical concept of the present invention. For example, in the above exemplary embodiment, a data diffusion state when the sequence number k=8 is illustrated in FIG. 5. However, by using the above exemplary permutation patterns, when the sequence number k is in the range of 6 to 16, optimum diffusion properties can be obtained.

In addition, for example, the number of rounds of the processing to be performed, the data division number, the functions F, and the non-linear conversion method can be changed based on various elements, such as based on performance of a device to which the present invention is applied and security strength required of encryption.

The disclosure of the above NPL is incorporated herein by reference thereto. Modifications and adjustments of the exemplary embodiments and examples are possible within the scope of the overall disclosure (including the claims and the drawings) of the present invention and based on the basic technical concept of the present invention. Various combinations and selections of various disclosed elements (including the elements in each of the claims, examples, drawings, etc.) are possible within the scope of the claims and the drwawings of the present invention. That is, the present invention of course includes various variations and modifications that could be made by those skilled in the art according to the overall disclosure including the claims and the technical concept.

### REFERENCE SIGNS LIST

10 communication apparatus

11 non-linear conversion means

12 permutation processing means

13 k-sequence-data randomizing means

20 non-linear conversion unit

21 permutation processing unit

70 expanded key generation means

71 encryption means

72 decryption means

100 data compression means

102 encoding means

104 data decompression means

710, 720 k-sequence-data randomizing means

711 non-linear conversion means

712 permutation processing means

713 inverse permutation processing means

1. A cryptographic method, performing k-sequence-data randomizing processing a predetermined number of times, one round of the processing comprising steps of:
performing conversion processing on k pieces (k is an even number of 6 or more) of n-bit sequence data obtained by dividing n×k bit block data so that i-th sequence data and (i+1)th sequence data (i=1, 2, . . . , k−1) interacts with each other and outputting k pieces of data W₁, W₂, . . . ,Wₖ; and
permutating the data W₁, W₂, . . . , Wₖ based on a predetermined rule.

2. The cryptographic method according to claim 1;
wherein, if a permutation for replacing the data W₁, W₂, . . . , Wₖ (k≦16) with data W_{j[1]}, W_{j[2]}, . . . , W_{j[k]}. is expressed as {j[1],j[2], . . . , j[k]}, when k=6, a permutation expressed as {4,1,2,5,6,3} is performed.

3. The cryptographic method according to claim 1;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=8, a permutation expressed as {6,1,8,3,4,7,2,5} or {4,1,8,5,6,7,2,3} is performed.

4. The cryptographic method according to claim 1;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=10, a permutation expressed as any one of the following expressions (1) is performed:
{4,1,8,3,10,5,6,9,2,7}
{4,1,6,3,10,7,2,9,8,5}
{4,1,6,3,10,7,8,9,2,5}
{6,1,8,3,4,7,2,9,10,5}
{6,1,8,3,10,7,2,9,4,5}
{6,1,8,3,10,7,4,9,2,5}
{4,1,8,5,2,3,6,9,10,7}
{4,1,8,5,2,7,6,9,10,3}
{4,1,8,5,10,7,6,9,2,3} (1).

5. The cryptographic method according to claim 1;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=12, a permutation expressed as any one of the following expressions (2) is performed:
{8,1,10,3,12,5,4,9,6,11,2,7}
{6,1,10,3,12,7,2,5,8,11,4,9}
{6,1,10,3,12,7,4,5,8,11,2,9}
{6,1,8,3,4,7,12,9,10,11,2,5}
{6,1,10,3,4,7,12,9,2,11,8,5}
{6,1,10,3,12,7,2,9,8,11,4,5}
{6,1,10,3,12,7,4,9,8,11,2,5}
{4,1,8,5,2,3,12,9,6,11,10,7}
{4,1,8,5,2,3,12,9,10,11,6,7}
{4,1,12,5,10,7,6,9,8,11,2,3}
{6,3,10,1,4,7,12,5,8,11,2,9}
{6,3,10,1,12,7,4,5,8,11,2,9}
{6,3,10,1,12,7,2,9,8,11,4,5}
{6,3,10,1,12,7,4,9,8,11,2,5}
{6,3,2,5,8,1,12,9,4,11,10,7} (2).

6. The cryptographic method according to claim 1;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=14, a permutation expressed as {4,1,10,5,14,7,6,3,2,11,12,13,8,9} or {4,1,10,5,6,7,2,9,14,11,8,13,12,3} is performed.

7. The cryptographic method according to claim 1;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=16, a permutation expressed as any one of the following expressions (3) is performed:
{10,1,14,3,12,7,16,5,8,11,4,13,6,15,2,9}
{6,1,8,3,12,7,16,9,2,5,4,13,10,15,14,11}
{6,1,12,3,16,7,4,9,2,5,10,13,8,15,14,11}
{6,1,12,3,16,7,14,9,2,5,10,13,8,15,4,11}
{6,1,8,3,12,7,16,9,14,11,4,13,10,15,2,5}
{6,1,10,3,14,7,4,9,16,11,8,13,12,15,2,5}
{6,1,10,3,14,7,12,9,16,11,8,13,4,15,2,5}
{8,1,10,5,14,3,6,9,16,11,12,13,4,15,2,7}
{8,1,10,5,16,3,6,9,14,11,12,13,4,15,2,7}
{8,1,10,5,16,3,14,9,6,11,12,13,4,15,2,7}
{4,1,10,5,16,7,6,3,14,11,12,13,8,15,2,9}
{10,1,2,5,12,7,6,3,8,11,16,13,14,15,4,9}
{4,1,10,5,16,7,6,9,14,11,12,13,8,15,2,3} (3).

8. The cryptographic method according to claim 1;
wherein, if a permutation for replacing the data W₁, W₂, . . . , Wₖ (k≦16) with data W_{j[1]}, W_{j[2]}, . . . , W_{j[k]}. is expressed as {j[1], j[2]., . . . , j[k]}, depending on the number k of sequences, a permutation expressed as any one of the following expressions (4) is performed:
When k=6,
{4,1,2,5,6,3};
When k=8,
{6,1,8,3,4,7,2,5}
{4,1,8,5,6,7,2,3};
When k=10,
{4,1,8,3,10,5,6,9,2,7}
{4,1,6,3,10,7,2,9,8,5}
{4,1,6,3,10,7,8,9,2,5}
{6,1,8,3,4,7,2,9,10,5}
{6,1,8,3,10,7,2,9,4,5}
{6,1,8,3,10,7,4,9,2,5}
{4,1,8,5,2,3,6,9,10,7}
{4,1,8,5,2,7,6,9,10,3}
{4,1,8,5,10,7,6,9,2,3};
When k=12,
{8,1,10,3,12,5,4,9,6,11,2,7}
{6,1,10,3,12,7,2,5,8,11,4,9}
{6,1,10,3,12,7,4,5,8,11,2,9}
{6,1,8,3,4,7,12,9,10,11,2,5}
{6,1,10,3,4,7,12,9,2,11,8,5}
{6,1,10,3,12,7,2,9,8,11,4,5}
{6,1,10,3,12,7,4,9,8,11,2,5}
{4,1,8,5,2,3,12,9,6,11,10,7}
{4,1,8,5,2,3,12,9,10,11,6,7}
{4,1,12,5,10,7,6,9,8,11,2,3}
{6,3,10,1,4,7,12,5,8,11,2,9}
{6,3,10,1,12,7,4,5,8,11,2,9}
{6,3,10,1,12,7,2,9,8,11,4,5}
{6,3,10,1,12,7,4,9,8,11,2,5}
{6,3,2,5,8,1,12,9,4,11,10,7};
When k=14,
{4,1,10,5,14,7,6,3,2,11,12,13,8,9}
{4,1,10,5,6,7,2,9,14,11,8,13,12,3};
When k=16,
{10,1,14,3,12,7,16,5,8,11,4,13,6,15,2,9}
{6,1,8,3,12,7,16,9,2,5,4,13,10,15,14,11}
{6,1,12,3,16,7,4,9,2,5,10,13,8,15,14,11}
{6,1,12,3,16,7,14,9,2,5,10,13,8,15,4,11}
{6,1,8,3,12,7,16,9,14,11,4,13,10,15,2,5}
{6,1,10,3,14,7,4,9,16,11,8,13,12,15,2,5}
{6,1,10,3,14,7,12,9,16,11,8,13,4,15,2,5}
{8,1,10,5,14,3,6,9,16,11,12,13,4,15,2,7}
{8,1,10,5,16,3,6,9,14,11,12,13,4,15,2,7}
{8,1,10,5,16,3,14,9,6,11,12,13,4,15,2,7}
{4,1,10,5,16,7,6,3,14,11,12,13,8,15,2,9}
{10,1,2,5,12,7,6,3,8,11,16,13,14,15,4,9}
{4,1,10,5,16,7,6,9,14,11,12,13,8,15,2,3} (4).

9. A cryptographic device, comprising:
a predetermined number of rounds of k-sequence-data randomizing means, one round of the means comprising:
a conversion means for performing conversion processing on k pieces (k is an even number of 6 or more) n-bit data obtained by dividing n×k bit block data so that i-th sequence data and (i+1)th sequence data (i=1, 2, . . . , k−1) interacts with each other and outputting k pieces of data W₁, W₂, . . . , Wₖ; and
a permutation means for permutating the data W₁, W₂, . . . , Wₖ based on a predetermined rule.

10. A non-transient computer-readable storage medium that records a cryptographic program, the program causing a computer, to which k pieces (k is an even number of 6 or more) of n-bit data obtained by dividing n×k bit block data is inputted, to perform k-sequence-data randomizing processing for a predetermined number of rounds, one round of the processing comprising processes of:
performing conversion processing so that i-th sequence data and (i+1)th sequence data (i=1, 2, k−1) interacts with each other and outputting k pieces of data W₁, W₂, . . . , Wₖ; and
permutating the data W₁, W₂, . . . , Wₖ based on a predetermined rule.

11. The cryptographic method according to claim 2;
wherein, if a permutation for replacing the data W₁, W₂, . . . ,Wₖ (k≦16) with data W_{j[1]}, W_{j[2]}, . . . , W_{j[k]} is expressed as {j[1], j[2], . . . , j[k]}, when k=10, a permutation expressed as any one of the following expressions (1) is performed:
{4,1,8,3,10,5,6,9,2,7}
{4,1,6,3,10,7,2,9,8,5}
{4,1,6,3,10,7,8,9,2,5}
{6,1,8,3,4,7,2,9,10,5}
{6,1,8,3,10,7,2,9,4,5}
{6,1,8,3,10,7,4,9,2,5}
{4,1,8,5,2,3,6,9,10,7}
{4,1,8,5,2,7,6,9,10,3}
{4,1,8,5,10,7,6,9,2,3} (1).

12. The cryptographic method according to claim 3;
wherein, if a permutation for replacing the data W₁, W₂, . . . , Wₖ (k≦16) with data W_{[1]}, W_{j [2]}, . . . , W_{j[k]} is expressed as {j[1], j[2], . . . , j[k]}, when k=10, a permutation expressed as any one of the following expressions (1) is performed:
{4,1,8,3,10,5,6,9,2,7}
{4,1,6,3,10,7,2,9,8,5}
{4,1,6,3,10,7,8,9,2,5}
{6,1,8,3,4,7,2,9,10,5}
{6,1,8,3,10,7,2,9,4,5}
{6,1,8,3,10,7,4,9,2,5}
{4,1,8,5,2,3,6,9,10,7}
{4,1,8,5,2,7,6,9,10,3}
{4,1,8,5,10,7,6,9,2,3} (1).

13. The cryptographic method according to claim 2;
wherein, if a permutation for replacing the data W₁, W₂, . . . , Wₖ (k≦16) with data W_{j[1]}, W_{j[2].}, . . . , W_{j[k]} is expressed as {j[1], j[2], . . . , j[k]}, when k=12, a permutation expressed as any one of the following expressions (2) is performed:
{8,1,10,3,12,5,4,9,6,11,2,7}
{6,1,10,3,12,7,2,5,8,11,4,9}
{6,1,10,3,12,7,4,5,8,11,2,9}
{6,1,8,3,4,7,12,9,10,11,2,5}
{6,1,10,3,4,7,12,9,2,11,8,5}
{6,1,10,3,12,7,2,9,8,11,4,5}
{6,1,10,3,12,7,4,9,8,11,2,5}
{4,1,8,5,2,3,12,9,6,11,10,7}
{4,1,8,5,2,3,12,9,10,11,6,7}
{4,1,12,5,10,7,6,9,8,11,2,3}
{6,3,10,1,4,7,12,5,8,11,2,9}
{6,3,10,1,12,7,4,5,8,11,2,9}
{6,3,10,1,12,7,2,9,8,11,4,5}
{6,3,10,1,12,7,4,9,8,11,2,5}
{6,3,2,5,8,1,12,9,4,11,10,7} (2).

14. The cryptographic method according to claim 3;
wherein, if a permutation for replacing the data W₁, W₂, . . . , Wₖ (k≦16) with data W_{j[1]}, W_{j[2].}, . . . , W_{j[k]} is expressed as {j[1], j[2], . . . , j[k]}, when k=12, a permutation expressed as any one of the following expressions (2) is performed:
{8,1,10,3,12,5,4,9,6,11,2,7}
{6,1,10,3,12,7,2,5,8,11,4,9}
{6,1,10,3,12,7,4,5,8,11,2,9}
{6,1,8,3,4,7,12,9,10,11,2,5}
{6,1,10,3,4,7,12,9,2,11,8,5}
{6,1,10,3,12,7,2,9,8,11,4,5}
{6,1,10,3,12,7,4,9,8,11,2,5}
{4,1,8,5,2,3,12,9,6,11,10,7}
{4,1,8,5,2,3,12,9,10,11,6,7}
{4,1,12,5,10,7,6,9,8,11,2,3}
{6,3,10,1,4,7,12,5,8,11,2,9}
{6,3,10,1,12,7,4,5,8,11,2,9}
{6,3,10,1,12,7,2,9,8,11,4,5}
{6,3,10,1,12,7,4,9,8,11,2,5}
{6,3,2,5,8,1,12,9,4,11,10,7} (2).

15. The cryptographic method according to claim 4;
wherein, if a permutation for replacing the data W₁, W₂, . . . , Wₖ (k≦16) with data W_{j[1]}, W_{j[2].}, . . . , W_{j[k]} is expressed as {j[1], j[2], . . . , j[k]}, when k=12, a permutation expressed as any one of the following expressions (2) is performed:
{8,1,10,3,12,5,4,9,6,11,2,7}
{6,1,10,3,12,7,2,5,8,11,4,9}
{6,1,10,3,12,7,4,5,8,11,2,9}
{6,1,8,3,4,7,12,9,10,11,2,5}
{6,1,10,3,4,7,12,9,2,11,8,5}
{6,1,10,3,12,7,2,9,8,11,4,5}
{6,1,10,3,12,7,4,9,8,11,2,5}
{4,1,8,5,2,3,12,9,6,11,10,7}
{4,1,8,5,2,3,12,9,10,11,6,7}
{4,1,12,5,10,7,6,9,8,11,2,3}
{6,3,10,1,4,7,12,5,8,11,2,9}
{6,3,10,1,12,7,4,5,8,11,2,9}
{6,3,10,1,12,7,2,9,8,11,4,5}
{6,3,10,1,12,7,4,9,8,11,2,5}
{6,3,2,5,8,1,12,9,4,11,10,7} (2).

16. The cryptographic method according to claim 2;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=14, a permutation expressed as {4,1,10,5,14,7,6,3,2,11,12,13,8,9} or {4,1,10,5,6,7,2,9,14,11,8,13,12,3} is performed.

17. The cryptographic method according to claim 3;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k=14, a permutation expressed as {4,1,10,5,14,7,6,3,2,11,12,13,8,9} or {4,1,10,5,6,7,2,9,14,11,8,13,12,3} is performed.

18. The cryptographic method according to claim 4;
wherein, if a permutation for replacing the data Wᵢ, W₂, . . . , Wₖ (k≦16) with data W_{j[1]}, W_{j[2]}, . . . , W_{j[k]} is expressed as {j[1], j[2], . . . , j[k]}, when k=14, a permutation expressed as {4,1,10,5,14,7,6,3,2,11,12,13,8,9} or {4,1,10,5,6,7,2,9,14,11,8,13,12,3} is performed.

19. The cryptographic method according to claim 5;
wherein, if a permutation for replacing the data W₁, W₂, . . . , Wₖ (k≦16) with data W_{j[1]}, W_{j[2]}, . . . , W_{j[k]} is expressed as {j[1], j[2], . . . , j[k]}, when k =14, a permutation expressed as {4,1,10,5,14,7,6,3,2,11,12,13,8,9} or {4,1,10,5,6,7,2,9,14,11,8,13,12,3} is performed.
